(19) United States
(12) Patent Application Publication
(10) Pub. No.: US 2026/0331614 A1
(43) Pub. Date: Oct. 22, 2026

(54) BATTERY CELL FORMATION DEVICE

(71) Applicant: LG Energy Solution, Ltd., Seoul (KR)

(72) Inventors: Jea Bong Jung, Daejeon (KR); Ji Hoon Cha, Daejeon (KR); Chang Bum Ahn, Daejeon (KR); Byung Man Choi, Daejeon (KR); Min Ki Woo, Daejeon (KR); Jun Yeong Seo, Daejeon (KR)

(21) Appl. No.: 19/123,037

(22) PCT Filed: May 8, 2024
(86) PCT No.: PCT/KR2024/006175

§ 371 Date: Apr. 21, 2025

(30) Foreign Application Priority Data
May 11, 2023 (KR) 10-2023-0061390

(51) Int. Cl. H01M 10/52; H01M 10/04; H01M 50/105; H01M 50/342

(52) U.S. Cl. CPC H01M 10/52; H01M 10/0481; H01M 50/105; H01M 50/3425

(57) ABSTRACT

A battery cell formation device according to one example includes a jig including a plurality of pressure plates movably provided to pressurize a plurality of battery cells, a gas remover provided to be movable together with a pressure plate of the plurality of pressure plates, and coupled to the pressure plate to face a gas pocket of the battery cell in contact with the pressure plate, and a position adjuster provided to adjust the position of the gas remover at the pressure plate.

### CROSS-REFERENCE TO RELATED APPLICATIONS

This application is a National Phase entry pursuant to 35 U.S.C. 371 of International Application PCT/KR2024/006175 filed on May 8, 2024, which claims priority to and the benefit of Korean Patent Application No. 10-2023-0061390 filed on May 11, 2023 in the Republic of Korea, the disclosure of which is incorporated herein by reference.

### TECHNICAL FIELD

The present disclosure relates to a battery cell formation device, and more specifically, relates to a battery cell formation device capable of performing, during an activation process of a plurality of battery cells, a gas removal process for each individual battery cell, and particularly, relates to a battery cell formation device in which a jig for pressurizing battery cells, and a gas remover are incorporated.

### BACKGROUND

FIG. 1 is a perspective diagram of a general pouch-type battery cell (1).

Referring to FIG. 1, the pouch-type battery cell (1) comprises an electrode assembly (2), a pouch case (6) surrounding the electrode assembly (2), and a pair of electrode tabs (3,4) electrically connected to the electrode assembly (2). The pouch case (6) may have a cup portion (8) in which the electrode assembly (2) is accommodated, and a gas pocket (5) in which gas is collected during an activation process.

The electrode assembly (2) is accommodated in the pouch case (6), and some regions of the electrode tabs (3, 4) are exposed to the outside of the pouch case (6). The electrode assembly (2) is an assembly in which a positive electrode plate, a negative electrode plate, and a separator are cross-laminated. The electrode assembly (2) is impregnated with an electrolyte solution in the inner space of the pouch case (6).

If the assembly of the pouch-type battery cell (1) is completed, the activation process of the pouch-type battery cell (1) is performed. The activation process stabilizes the structure of the battery cell and makes the battery cell (1) usable through the process of charging, aging, and discharging the pouch-type battery cell (1).

In the activation process, a large amount of gas is generated inside the pouch-type battery cell (1).

When the pouch-type battery cell (1) is expanded by the pressure of the gas upon the activation process, bonding force between an active material and a current collector may be weakened while the negative electrode plate, separator, and positive electrode plate are lifted in the lamination direction. Accordingly, a gas removal process is performed to remove the gas generated during the activation process.

If the gas generated inside the pouch-type battery cell (1) is not efficiently removed during the activation process, the gas occupies a certain space inside the pouch-type battery cell (1), thereby preventing uniform formation, and adversely affecting battery performance, such as capacity and output, and battery life.

The gas removal process is a process of removing the gas trapped inside the pouch-type battery cell (1), which pressurizes the pouch case (6), thereby causing to collect the gas in a gas pocket (5), and then pierces the gas pocket (5) to create a degas hole (7), and heat-fuses the degas hole (7) to be sealed.

FIG. 2 is a schematic diagram showing a conventional cell gas removal device (20), and FIG. 3 is a plan view of the cell gas removal device shown in FIG. 2.

Referring to FIGS. 2 and 3, the conventional cell gas removal device (20) is installed on the top of a cell charging jig (10). The cell charging jig (10) is a device in which the activation process of the pouch-type battery cell (1) is performed, which comprises a plurality of pressure plates (11) pressurizing the battery cell (1).

The cell gas removal device (20) is a separate device from the cell charging jig (10), which comprises a position adjuster (30) and a gas remover (70).

The position adjuster (30) is a device adjusting the position of the gas remover (70) so that the gas remover (70) faces the gas pocket (5) of the battery cell (1).

The conventional cell gas removal device (20) has a separate structure from the cell charging jig (10), which is provided to adjust the position of the gas remover (70) in three axes. Specifically, the position adjuster (30) comprises an x-axis driver (50), a y-axis driver (60), and a z-axis driver (40). Accordingly, the cell gas removal device (20) has a problem in that the layout of its components becomes overly complicated.

Therefore, it becomes difficult to secure a worker's visual field, and it is difficult to secure sufficient space for replacement of parts, and the like, so that the worker's maintenance and repair management is not easy.

As the conventional cell gas removal device (20) is provided to simultaneously perform the gas removal process on a plurality of pouch-type battery cells (1) arranged in the cell charging jig (10), there is a problem that the size of the entire device increases.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

The present disclosure is intended to provide a battery cell formation device in which a gas remover is integrated with a pressure plate for pressurizing the battery cell.

Also, the present disclosure is intended to provide a battery cell formation device capable of simplifying a position adjustment structure of a gas remover and adjusting the position of the gas remover with only one axial direction movement.

In addition, the present disclosure is intended to provide a battery cell formation device capable of performing on a plurality of battery cells, on which an activation process has been performed, a gas removal process.

Furthermore, the present disclosure is intended to provide a battery cell formation device capable of differently adjusting a position of a gas remover with respect to a gas pocket of a battery cell for each process, such as a piercing process, a gas suction process, and a sealing process.

A battery cell formation device according to one example of the present disclosure comprises a jig including a plurality of pressure plates movably provided to pressurize a plurality of battery cells, a gas remover provided to be movable together with a pressure plate of the plurality of pressure plates, and connected to the pressure plate to face a gas pocket of the battery cell in contact with the pressure plate, and a position adjuster provided to adjust the position of the gas remover on the pressure plate.

The position adjuster may be provided to be movable together with the pressure plate.

The battery cell formation device may comprise a first rail extending along the moving direction of the pressure plate and provided on the pressure plate to guide the movement of the gas remover, and a frame disposed apart from the pressure plate and provided with a guide rail guiding the movement of the position adjuster in the moving direction of the pressure plate.

The gas remover may comprise first and second vents, each provided to perform a gas removal process in a gas pocket of the battery cell disposed toward a first surface of the pressure plate and a gas pocket of the battery cell disposed toward a second surface of the pressure plate in the opposite direction to the first surface.

Also, the first and second vents may each be provided to be movable on the pressure plate, and the position adjuster may be provided to adjust a gap between the first and second vents. That is, the position adjuster may also increase the gap between the first and second vents by moving them away from each other and may reduce the gap between the first and second vents by moving them closer to each other.

In addition, the first vent may comprise a piercer provided to form a degas hole in the gas pocket of the battery cell, a vacuum provided to apply vacuum pressure to the degas hole and to suck the gas in the gas pocket, and a sealer sealing the degas hole.

Furthermore, the second vent may comprise a piercer provided to form a degas hole in the gas pocket of the battery cell, a vacuum provided to apply vacuum pressure to the degas hole and to suck the gas in the gas pocket, and a sealer sealing the degas hole.

Also, the vacuum may be provided to surround the piercer, and the sealer may be provided to surround the vacuum.

In addition, the sealer may be provided to seal a region with a diameter larger than that of the degas hole.

Furthermore, the vacuum may be provided to protrude toward the gas pocket of the battery cell rather than the sealer.

Also, the first and second vents may be provided so that the centers of the respective piercers are not located on the same side.

In addition, the position adjuster may be provided to adjust the gap between the first and second vents to a first gap upon operation of the piercer, and the position adjuster may be provided to adjust the gap between the first and second vents to a second gap, which is narrower than the first gap, upon operation of the vacuum.

Furthermore, the position adjuster may be provided to adjust the gap between the first and second vents to a third gap, which is larger than the first gap, upon operation of the sealer.

The position adjuster may comprise a vent driver movably coupled to the guide rail, a first connector connecting the first vent provided on the pressure plate and the vent driver, and a second connector connecting the second vent provided on the pressure plate and the vent driver.

Also, the vent driver may be provided to adjust the gap between the first and second connectors.

In addition, the vent driver may comprise a motor or a cylinder. The vent driver may be movably mounted along the guide rail of the frame. Accordingly, upon movement of the pressure plate, the first and second vents move together with the pressure plate, and the vent driver moves in the moving direction of the pressure plate along the guide rail.

As one example, the cylinder may comprise a pneumatic or oil hydraulic cylinder, where one end may be mounted on the first connector, and the other end may be mounted on the second connector. In this structure, the gap between the first and second connectors may be adjusted through the cylinder, and accordingly, the gap between the first and second vents on the pressure plate may be adjusted.

As another example, the vent driver may comprise a motor, where the motor may be an electric motor capable of rotating in forward and reverse directions. The motor may be connected to a gearbox provided to convert the rotational force of the motor into axial linear motion through a gear. At this time, one end of the gearbox may be mounted on the first connector, and the other end may be mounted on the second connector. In this structure, the gap between the first and second connectors may be adjusted through the cylinder, and accordingly, the gap between the first and second vents on the pressure plate may be adjusted.

Also, the position adjuster may comprise one or more joints connecting the first connector and the second connector.

In addition, the joint may comprise a first link hinge-connected to each of the first connector and the second connector, a second link disposed to intersect the first link and hinge-connected to each of the first connector and the second connector, and a hinge axis connecting the first link and the second link in the intersection region of the first link and the second link.

Furthermore, a plurality of the gas removers may be provided, and the gas removers may be provided individually for each pressure plate. Also, a plurality of the position adjusters may be provided, which may be provided individually for each gas remover. At this time, the vent drivers of the plurality of position adjusters may each be provided to be movable along the guide rail of the frame. In this structure, the battery cell formation device may comprise a jig including a plurality of pressure plates provided to pressurize a plurality of battery cells and provided to perform an activation process of the plurality of battery cells, a plurality of gas removers provided in each pressure plate to face gas pockets of the battery cells and provided to perform a gas removal process of the activation process for each battery cell, and a plurality of position adjusters connected to each gas remover and adjusting a position of each gas remover along the moving direction of the pressure plate.

In addition, the battery cell formation device may comprise a controller individually controlling operation of each gas remover and each position adjuster so that the gas removal process is performed on one or more battery cells among the plurality of battery cells arranged in the jig.

As discussed above, the battery cell formation device related to at least one example of the present disclosure has the following effects.

As the gas remover is integrated into the pressure plate for pressurizing the battery cell, it may be possible to promote miniaturization of the device.

Also, by performing the gas removal process for each battery cell during the activation process on the plurality of battery cells, it may be possible to improve the activation efficiency of the battery cells.

In addition, the conventional cell gas removal device is composed of a separate device from the cell charging jig to adjust the position of the cell gas removal device in three axis directions, whereas in the present disclosure, primarily, the gas remover may be moved together with the pressure plate, and secondarily, the position adjuster may adjust the position of the gas remover in one axis direction (for example, the moving direction of the pressure plate).

Furthermore, since the position adjuster may individually adjust the position of the gas remover, it may be possible to precisely control the venting position of the gas remover, and it may be possible to improve the gas removal efficiency of the gas remover.

In addition, the plurality of gas removers may be operated individually, and the gas removal process may also be individually performed on only some battery cells among the plurality of battery cells on which the activation process has been performed.

The effects of the present disclosure are not limited to the effects mentioned above and additional other effects not described above will be clearly understood from the description of the appended claims by those skilled in the art.

### BRIEF DESCRIPTION OF DRAWINGS

FIG. 1 is a perspective diagram of a general pouch-type battery cell.

FIG. 2 is a schematic diagram showing a conventional cell gas removal device.

FIG. 3 is a plan view of the cell gas removal device shown in FIG. 2.

FIG. 4 is a configuration diagram of a battery cell formation device according to one example of the present disclosure.

FIG. 5 is a perspective diagram schematically showing a coupled state of a gas remover and a position adjuster coupled to any one of a plurality of pressure plates.

FIG. 6 is a perspective diagram showing a first venting module.

FIG. 7 is a schematic plan view of the device shown in FIG. 5.

FIG. 8 is a diagram schematically showing a state cut along Line A-A in FIG. 5.

FIG. 9 is a diagram for explaining, in a battery cell formation device related to one example of the present disclosure, one operating state of a jig upon an activation process.

FIG. 10 is a diagram for explaining, in a battery cell formation device related to one example of the present disclosure, one operating state of a position adjuster upon a gas removal process.

FIG. 11 is a diagram showing a state where a battery cell is introduced into a jig.

FIG. 12 is a diagram for explaining a piercing step during a gas removal process.

FIG. 13 is a diagram for explaining a venting step during a gas removal process.

FIG. 14 is a diagram for explaining a sealing step during a gas removal process.

### DETAILED DESCRIPTION

Hereinafter, with reference to the accompanying drawings, a battery cell formation device according to one example of the present disclosure will be described.

In addition, regardless of the reference numerals, the same or corresponding components may be given by the same or similar reference numerals, duplicate descriptions thereof may be be omitted, and for convenience of explanation, the size and shape of each component member as shown may be exaggerated or reduced.

A battery cell formation device related to one example of the present disclosure may perform a gas removal process for each battery cell upon an activation process for a plurality of battery cells or after the activation process is completed.

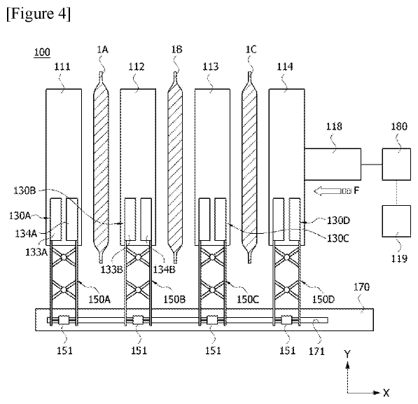

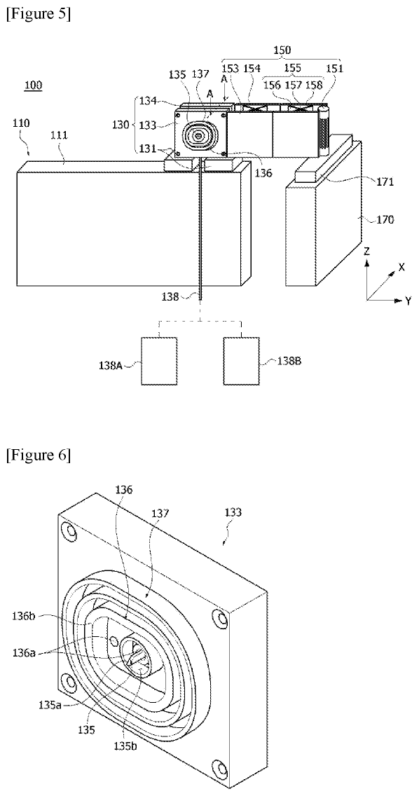

FIG. 4 is a configuration diagram of a battery cell formation device (100) according to one example of the present disclosure, and FIG. 5 is a perspective diagram schematically showing a coupled state of a gas remover and a position adjuster coupled to any one of a plurality of pressure plates.

Referring to FIGS. 4 and 5, the battery cell formation device (100) may comprise a jig (110), one or more gas removers (130), and one or more position adjusters (150).

Also, the battery cell formation device (100) may comprise a charger (119) for charging the plurality of battery cells (1A to 1C) arranged in the jig (110), and a frame (170) disposed apart from the jig (110), and a controller (180). In addition, the controller (180) is provided to control the operation of the jig (110), the charger (119), the gas remover (130), and the position adjuster (150). The controller may be an electronic processor, logical electric circuit, etc.

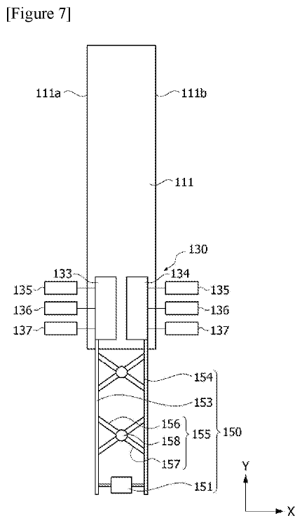

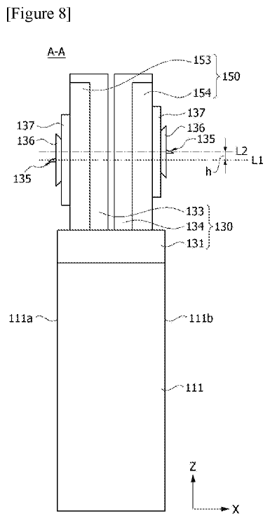

In addition, FIG. 6 is a perspective diagram showing a first vent (133), FIG. 7 is a schematic plan view of the device shown in FIG. 5, and FIG. 8 is a diagram schematically showing a state cut along Line A-A in FIG. 5.

Referring to FIGS. 4 and 5, the jig (110) is a device performing a battery cell activation process. The jig (110) may comprise a plurality of pressure plates (111 to 114), and a jig driver (118) for moving the pressure plates (111 to 114). The plurality of battery cells (1A to 1C) are arranged within the jig (110).

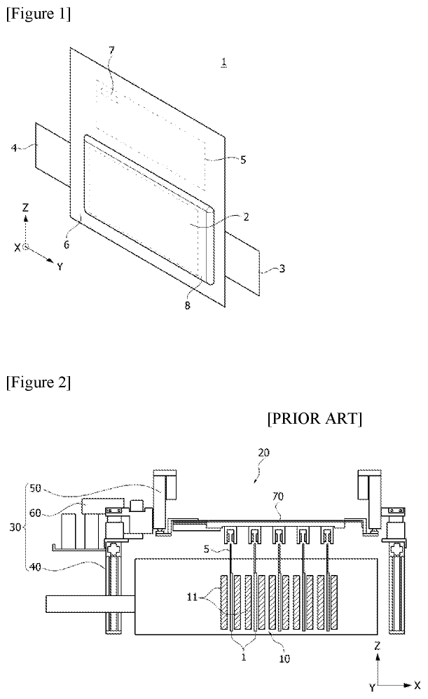

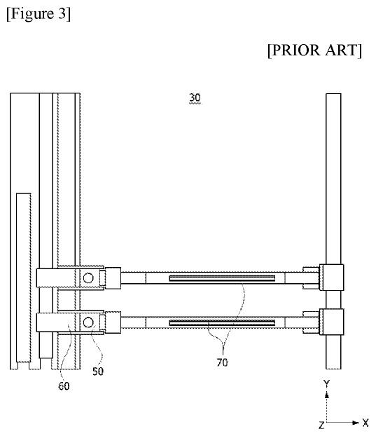

Each battery cell (1A to 1C) may be disposed in a space between two adjacent pressure plates (111 to 114). In addition, each battery cell (1A to 1C) may be the same as the battery cell (1) described with reference to FIG. 1, and for convenience of explanation, different reference numerals have been imparted depending on the order in which they are arranged in the jig (110).

The jig driver (118) may comprise a driving motor and a driving shaft, and when the driving shaft rotates by rotation of the driving motor, the plurality of pressure plates (11 to 114) engaged therewith moves in one direction. Accordingly, the jig (110) may pressurize both sides of the battery cells (1A to 1C). As such, upon the activation process, the jig driver (118) moves the plurality of pressure plates (111 to 114) in one direction (x-axis direction), and provides the battery cells (1A~1C) disposed between two adjacent pressure plates (111 to 114) with a predetermined pressing force (F).

Referring to FIG. 1, the pouch-type battery cell (1) related to this example comprises an electrode assembly (2), and a pouch case (6) surrounding the electrode assembly (2), and a pair of electrode tabs (3, 4) electrically connected to the electrode assembly (2). The pouch case (6) may have a cup portion (8) in which the electrode assembly (2) is accommodated, and a gas pocket (5) in which gas is collected during the activation process.

In this disclosure, the x-axis direction represents the thickness direction of the battery cell (1), the y-axis direction represents the longitudinal direction (the direction connecting the pair of electrode tabs) of the battery cell (1), and the z-axis direction represents the width direction of the battery cell (1). In addition, the x-axis direction indicates the arrangement direction of the pressure plates, or the moving direction of the pressure plates.

The cup portion (8) and the gas pocket (5) may be positioned apart from each other along the width direction of the battery cell (1).

The plurality of battery cells (1A to 1C) are arranged in an upright state within the jig (110), and the state where the battery cells are erect may mean that the gas pocket (5) is located above and the cup portion (8) is located below.

At this time, each pressure plate (111 to 114) may be provided to pressurize the cup portion (8) of the battery cell (1). When the pressure plates (111 to 114) pressurize the cup portion (8) upon the activation process, gas generated inside the battery cell (1) may be moved to the gas pocket (5), and the gas pocket (5) may expand.

In this disclosure, the plurality of pressure plates (111 to 114) may comprise a first pressure plate (111) to a fourth pressure plate (114). The first to fourth pressure plates (111 to 114) represent four pressure plates that are randomly continuous along the arrangement direction of the plurality of pressure plates. Also, the arrangement direction of the plurality of pressure plates and the moving direction of each pressure plate may be in the same direction (x-axis direction). In addition, in this disclosure, the respective battery cells disposed between two adjacent pressure plates along the direction from the first pressure plate (111) toward the fourth pressure plate (114) may be referred to as the first battery cell (1A) to the third battery cell (1C).

The first battery cell (1A) is disposed between the first pressure plate (111) and the second pressure plate (112); the second battery cell (1B) is disposed between the second pressure plate (112) and the third pressure plate (113); and the third battery cell (1C) is disposed between the third pressure plate (113) and the fourth pressure plate (114).

The jig (110) operates for the plurality of pressure plates (111 to 114) to be spaced apart at predetermined intervals so that upon insertion of the battery cells (1A, 1B, 1C), the battery cells (1A, 1B, 1C) can be inserted. When charging/discharging the battery cells after completing the insertion of the battery cells (1A, 1B, 1C), the jig (110) operates for the plurality of pressure plates (111 to 114) to pressurize the plurality of battery cells (1A, 1B, 1C).

Referring to FIGS. 4 and 5, the gas remover (130) is provided to be movable together with one pressure plate (for example, 111) of the plurality of pressure plates, and connected to the pressure plate (111) to face the gas pocket (5) of the battery cell (1A) in contact with the pressure plate (111). The gas remover (130) may be provided for each pressure plate, and in this structure, the battery cell formation device (100) may comprise a plurality of gas removers (130). Also, the plurality of gas removers (130: 130A to 130D) may be mounted on the respective pressure plates (111 to 114).

The position adjusters (150) may be provided to adjust the position of the gas remover (130) on the pressure plate (111). Also, the position adjuster (150) may be provided to be movable together with the pressure plate (111). That is, when the pressure plate (111) is moved by the jig driver (118), the position adjuster may be moved together by the driving force in which the pressure plate (111) is moved. To this end, the position adjuster (150) may be connected to the gas remover (130). In addition, in the state where the gas remover(s) (130: 130A to 130D) are mounted on the respective pressure plates (111 to 114), the formation device (100) may be provided with a plurality of position adjusters (150: 150A to 150D).

Referring to FIG. 5, the battery cell formation device (100) may comprise a first rail (131) extending along the moving direction of the pressure plate (111) and provided on the pressure plate (111) to guide the movement of the gas remover (130), and a frame (170) disposed apart from the pressure plate (111) and provided with a guide rail (171) guiding the movement of the position adjuster (150) in the moving direction of the pressure plate (111).

The position adjuster (150) may be connected to the gas remover (130), and moved in the moving direction of the pressure plate (111) along the guide rail (171) by the movement of the gas remover (130).

Referring to FIGS. 5, 7, and 8, each gas remover (130) is a device for performing a process of removing gas from a gas pocket (5) of the battery cell (1A to 1C) arranged in the jig (110). The gas remover (130) provided on any one pressure plate (111) may comprise first and second vents (133, 134) each provided to perform a gas removal process in a gas pocket (5) of the battery cell disposed toward a first surface (111a) of the pressure plate (111) and a gas pocket (5) of the battery cell disposed toward a second surface (111b) of the pressure plate (111) in the opposite direction to the first surface (111a). At this time, the first and second vents (133, 134) may each be provided to be movable on the pressure plate (111). The first and second vents (133, 134) may be provided so that the position of the battery cell in the width direction (Z-axis direction) is maintained constant, and they are movable in the thickness direction of the battery cell (x-axis direction, moving direction of the pressure plate).

The first rail (131) may be provided on the top of each pressure plate (111 to 114), and the pair of vents (133, 134) may be movably mounted on the first rail (131). The first rail (131) is provided to guide the movement of the pair of vents (133, 134) in the arrangement direction (X) of the pressure plate (111).

Also, the first vent (133) may comprise a piercer (135) provided to form a degas hole (7, see FIG. 1) in the gas pocket (5) of the battery cell (1), a vacuum (136) provided to apply vacuum pressure to the degas hole (7) and to suck the gas in the gas pocket (5), and a sealer (137) for sealing the degas hole (7).

In addition, the second vent (134) may comprise a piercer (135) provided to form a degas hole (7, see FIG. 1) in the gas pocket (5) of the battery cell (1), a vacuum (136) provided to apply vacuum pressure to the degas hole (7) and to suck the gas in the gas pocket (5), and a sealer (137) for sealing the degas hole (7).

The piercer (135), vacuum (136), and sealer (137) of the first vent (133) may be exposed toward the first surface (111a) of the pressure plate (111), and the piercer (135), vacuum (136), and sealer (137) of the second vent (134) are exposed toward the second surface (111b) of the pressure plate (111).

The piercer (135) is a device for piercing the gas pocket (5) so that the degas hole (7) is formed in the gas pocket (5) of the battery cell, the vacuum (136) is a device for applying vacuum pressure to the gas hole (7) of the gas pocket (5) and sucking the gas in the gas pocket (5), and the sealer (137) is a device for sealing the degas hole (7) after the operation of the vacuum (136) is completed.

In this way, the gas removal process may be simultaneously performed on two battery cells disposed on both sides (111a, 111b) of the pressure plate (111) through the first and second vents (133, 134).

Referring to FIGS. 6 and 8, the piercer (135) may comprise a needle (135a) for forming the degas hole (7), and a predetermined space (135b) is provided around the needle (135a).

The vacuum (136) may be provided to surround the piercer (135). The vacuum (136) may have one or more discharge holes (136a) and may comprise a contact pad (136b) for contacting the gas pocket (5). The contact pad (136b) may be provided to contact a region with a diameter larger than that of the degas hole (7) and may be provided to surround the space (135b) of the piercer (135). The discharge hole (136a) is located inside the contact pad (136b), where the vacuum pressure may be applied through the discharge hole (136a). In addition, the contact pad (136b) may be provided to be compressible.

Also, the sealer (137) may be provided to surround the vacuum (136). The sealer (137) may comprise a heater, and the sealer (137) may be provided to seal a region with a diameter larger than that of the degas hole (7). In addition, the sealer (137) may be provided to seal a region with a larger diameter than the region where the contact pad (136b) contacts the gas pocket (5).

The vacuum (136) and the sealer (137) may be arranged in a concentric circle based on the piercer (135).

Also, the vacuum (136) may be provided to protrude toward the gas pocket (5) of the battery cell rather than the sealer (137). As one example, the contact pad (136b) may be provided to protrude toward the gas pocket (5) of the battery cell rather than the sealer (137).

Referring to FIG. 8, the first and second vents (133, 134) may be provided so that the centers of the respective piercers (135) are not located on the same side. That is, a virtual line segment (L1) passing through the center of the piercer (135) of the first vent (133) and a virtual line segment (L2) passing through the center of the piercer (135) of the second vent (134) do not coincide, which may be spaced apart by a predetermined distance (h) along the width direction of the battery cell. That is, the piercer (135) of the first vent (133) and the piercer (135) of the second vent (134) may be spaced apart by a predetermined distance (h) along the width direction (z-axis direction) of the battery cell.

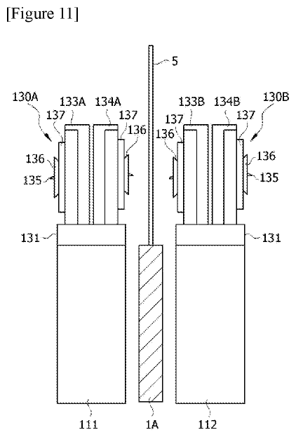

Through this structure, when the piercer operates (piercing process), it may be possible to prevent the piercer (135) of the second vent (134A, see FIG. 11) on the first pressure plate (111) and the piercer (135) of the first vent (133B, see FIG. 11) on the second pressure plate (112) from colliding.

Referring to FIG. 5, a utility line (138) may be connected to the pair of vents (133, 134). The utility line (138) may also be built into the pressure plates (111 to 114) and may also be connected to the pair of vents (133, 134), respectively. The utility line (138) may comprise a power supply line (138A) and a vacuum pressure supply line (138B).

The power supply line (138A) may apply power to the piercer (135), the vacuum (136), and the sealer (137), respectively, and the vacuum pressure supply line (138B) may supply vacuum pressure to the vacuum (136) and connected to the discharge hole (136b).

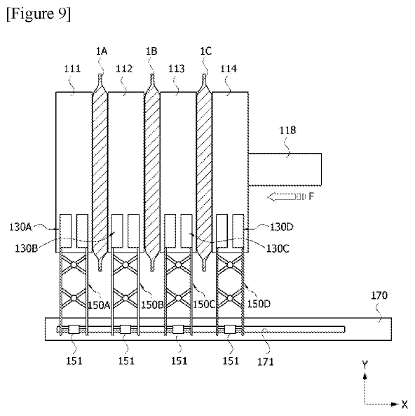

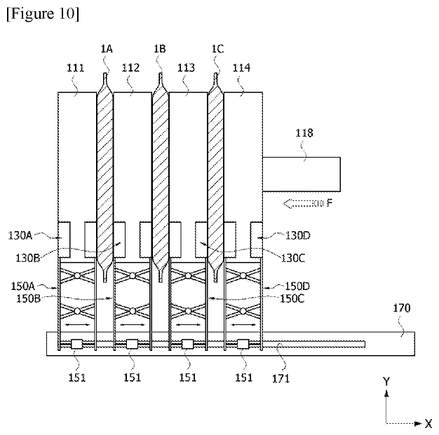

FIG. 9 is a diagram for explaining, in a battery cell formation device related to one example of the present disclosure, one operating state of a jig upon an activation process, and FIG. 10 is a diagram for explaining, in a battery cell formation device related to one example of the present disclosure, one operating state of a position adjuster upon a gas removal process.

Referring to FIGS. 5 and 7, the position adjuster (150) may comprise a vent driver (151) movably coupled to the guide rail (171), a first connector (153) connecting the vent driver (151) and the first vent (133) provided on the pressure plate (111), and a second connector (154) connecting the vent driver (151) and the second vent (134) provided on the pressure plate (111). In addition, the vent driver (151) may be provided to adjust the gap between the first and second connectors (153, 154).

The vent driver (151) may comprise a motor or a cylinder.

In addition, the vent driver (151) may be movably mounted along the guide rail (171) of the frame (170). Accordingly, upon movement of the pressure plate (111), the first and second vents (133, 134) move together with the pressure plate (111), and the vent driver (151) moves in the moving direction (x-axis direction) of the pressure plate (111) along the guide rail (171).

Furthermore, the position adjuster (150) may comprise one or more joints (155) connecting the first connector (153) and the second connector (154).

In addition, the joint (155) may comprise a first link (156) hinge-connected to each of the first connector (153) and the second connector (154), a second link (157) disposed to intersect the first link (156) and hinge-connected to each of the first connector (153) and the second connector (54), and a hinge axis (158) connecting the first link (156) and the second link (157) in the intersection region of the first link (156) and the second link (157).

The pair of vents (133, 134) provided on the first rail (131) of the pressure plate (111) may be provided so that the gap is adjusted along the arrangement direction (X) of the pressure plate (111) by the position adjuster (150) in a state where the pressure plate (111) is stopped. In addition, the pair of vents (133, 134) may be provided to vent the gas pockets (5) of different battery cells disposed on both sides (111a, 111b) of the pressure plate (111) upon the gas removal process.

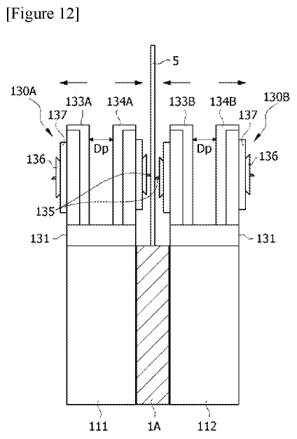

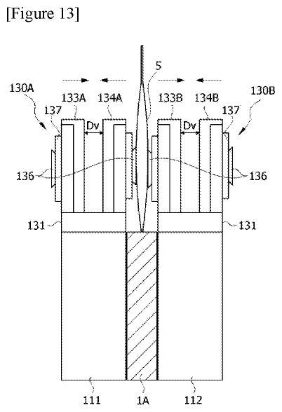

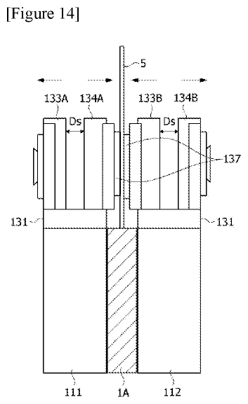

FIG. 11 is a diagram showing a state where a battery cell is introduced into a jig, FIG. 12 is a diagram for explaining a piercing step during a gas removal process, FIG. 13 is a diagram for explaining a venting step during a gas removal process, and FIG. 14 is a diagram for explaining a sealing step during a gas removal process.

The plurality of position adjusters (150: 150A to 150D) may be coupled to each gas remover (130). The plurality of position adjusters (150: 150A to 150D) adjust the gap between the pair of vents (133A and 134A, 133B and 134B) provided in each gas remover (130) upon the gas removal process.

The plurality of position adjusters (150) may be movably mounted on the guide rail (171).

Each position adjuster (150) moves in the moving direction of each pressure plate (111 to 114) along the guide rail (171) upon operation of the jig driver (181). In addition, each position adjuster (150) is provided to stop on the guide rail (171) when the movement of the pressure plate stops.

Each position adjuster (150) is provided to adjust the gap between the pair of vents (133, 134) provided on the pressure plate along the moving direction (X) of the pressure plate.

Also, the position adjuster (150) may be provided to adjust the gap between the first and second vents (133, 134) to a first gap (Dp) upon operation of the piercer (135), and the position adjuster (150) may be provided to adjust the gap between the first and second vents (133, 134) to a second gap (Dv), which is narrower than the first gap (Dp), upon operation of the vacuum (136).

In addition, the position adjuster (150) may be provided to adjust the gap between the first and second vents (133, 134) to a third gap (Ds), which is larger than the first gap (Dp), upon operation of the sealer (137).

Referring to FIG. 12, each position adjuster (150) adjusts the position of the pair of vents (133A and 134A, 133B and 134B) so that upon operation of the piercer (135) of the gas remover (130A) provided on the first pressure plate (111) and the piercer (135) of the gas remover (130B) provided on the second pressure plate (112), the pair of vents (133A and 134A, 133B and 134B) are spaced apart from each other to the first gap (Dp, see FIG. 11(b)).

Here, the first gap (Dp) means a gap that when the piercer (135) of each vent contacts the gas pocket (5) of the battery cell (1A), the pair of vents (133A and 134A, 133B and 134B) are spaced apart from each other.

Referring to FIG. 13, each position adjuster (150) adjusts the position of the pair of vents (133A and 134A, 133B and 134B) so that upon operation of the vacuum (136), the pair of vents (133A and 134A, 133B and 134B) are spaced apart from each other to the second gap (see Dv) which is narrower than the first gap (Dp).

Here, the second gap (Dv) means a gap that when the vacuum (136) of each vent contacts the gas pocket (5) of the battery cell (1A), the pair of vents (133, 134) are spaced apart from each other. Meanwhile, when gas is removed, the gas pocket (5) is expanded along the thickness direction of the battery cell.

Referring to FIG. 14, each position adjuster (150) adjusts the position of the pair of vents (133A and 134A, 133B and 134B) so that upon operation of the sealer (137), the pair of vents (133A and 134A, 133B and 134B) are spaced apart from each other to the third gap (Ds) which is larger than the first gap (Dp).

Here, the third gap (Ds) means a gap that when the sealer (137) of each vent contacts the gas pocket (5) of the battery cell (1A), the pair of vents (133A and 134A, 133B and 134B) are spaced apart from each other.

In this way, each position adjuster (150: 150A to 150D) may precisely adjust the gap of the pair of vents (133, 134) for each gas remover (130). In addition, each position adjuster (150) may adjust the gap of the pair of vents (133, 134) differently according to each step of the gas removal process.

The operating direction of the vent driver (151) may be adjusted by the controller (180). The vent driver may comprise a motor and a gearbox, where when the motor rotates in a first operating direction, the gap between the first connector (153) and the second connector (154) may widen, and when the motor rotates in a second operating direction opposite to the first operating direction, the gap between the first connector (153) and the second connector (154) may narrow.

At least one joint (155) may connect the first connector (153) and the second connector (154) and may support the first connector (153) and the second connector (154).

Also, the first link (156) and the second link (157) may be arranged to cross each other in an X shape. The hinge axis (158) may connect the intersection of the first link (156) and the second link (157). The first link (156) and the second link (157) may be folded or unfolded around the hinge axis (158) depending on the gap between the first and second connectors (153, 154).

Referring to FIG. 10, when the gap between the first connector (153) and the second connector (154) is widened, the joint (155) is provided so that the first and second links (156, 157) are unfolded. Alternatively, referring to FIG. 9, when the gap between the first connector (153) and the second connector (154) narrows, the joint (155) is provided so that the first and second links (156, 157) are folded.

The plurality of gas removers (130) may comprise a first gas remover (130A) to a fourth gas remover (130D) according to the arrangement order of the plurality of pressure plates (111 to 114). In this instance, the first gas remover (130A) to the fourth gas remover (130D) have the same structure except that the positions of the installed pressure plates are different.

The plurality of position adjusters (150) may comprise a first position adjuster (150A) to a fourth position adjuster (150D) according to the arrangement order of the plurality of pressure plates (111 to 114).

Referring to FIG. 4, the first position adjuster (150A) is connected to the first gas remover (130A), the second position adjuster (150B) is connected to the second gas remover (130B), the third position adjuster (150C) is connected to the third gas remover (130C), and the fourth position adjuster (150D) is connected to the fourth gas adjuster (130D).

During the activation process, the first to third battery cells (1A to 1C) are pressurized by the first to fourth pressure plates (111 to 114).

The controller (180) may control the operation of the jig (110) so that the battery cell activation process is performed. In addition, the controller (180) may individually control the operation of the plurality of gas removers (130) and the plurality of position adjusters (150) so that the gas removal process is performed only on selected battery cells among the plurality of battery cells (1A, 1B, 1C).

Hereinafter, for convenience of explanation, the processes of performing the activation process and gas removal process of the first battery cell (1A) will be described. The gas removal process of the first battery cell (1A) may be performed by the first gas remover (130A) and the second gas remover (130B).

Referring to FIGS. 11 to 14, the first gas remover (130A) is mounted on the first pressure plate (111). The first pressure plate (111) is a pressure plate disposed on one side of the first battery cell (1A), which is any one of the multiple battery cells (1A, 1B, 1C). Also, the second gas remover (130B) is mounted on the second pressure plate (112). The second pressure plate (112) is a pressure plate disposed on the other side of the first battery cell (1A). The second gas removal part (130B) is disposed to be spaced apart from the first gas remover (130A) along the arrangement direction (x-axis direction) of the pressure plates.

The first gas remover (130A) may comprise a first vent (133A) and a second vent (134A). The first vent (133A) and the second vent (134A) are disposed to be spaced apart from each other on the first rail portion (131) of the first pressure plate (111) along the arrangement direction (X) of the pressure plate (111).

The second gas remover (130B) may comprise a third vent (133B) and a fourth vent (134B). The third vent (133B) and the fourth vent (134B) are disposed to be spaced apart from each other on the first rail portion (131) of the second pressure plate (112) along the arrangement direction (X) of the pressure plates (111, 112).

The first position adjuster (150A) is connected to the first gas remover (130A), and the first position adjuster (150A) adjusts the gap between the first vent (133A) and the second vent (134A). In addition, the second position adjuster (150B) is connected to the second gas remover (130B), and the second position adjuster (150B) adjusts the gap between the third vent (133B) and the fourth vent (134B).

In this disclosure, the gas removal process may comprise a piercing step of forming a degas hole (7) in the gas pocket (5) of the battery cell (1A), a venting step of removing the gas in the gas pocket (5) through the degas hole (7), and a sealing step of sealing the degas hole (7).

Referring to FIGS. 10, 11, and 12, the first position adjuster (150A) operates to widen the gap between the first vent (133A) and the second vent (134A) during the piercing process. Also, the second position adjuster (150B) operates to widen the gap between the third vent (133B) and the fourth vent (134B) during the gas removal process.

Referring to FIG. 12, in the piercing step, the gap of the pair of vents in the first gas remover (130A) and the second gas remover (130B) is adjusted to the first gap (Dp).

When the gap of the pair of vents in the first gas remover (130A) and the second gas remover (130B) is adjusted to the first gap (Dp), the piercer (135) of the second vent (134A) and the piercer (135) of the third vent (133B) contact both sides of the gas pocket (5) of the first battery cell (1A). At this time, the piercers (135) of the second vent (134A) and the third vent (133B) may form degas holes in the gas pocket (5) on both sides of the first battery cell (1A).

Referring to FIG. 13, the first position adjuster (150A) operates so that upon the gas removal process after the piercing process, the first vent (133A) and the second vent (134A) narrow the gap while moving in a direction where they become closer. In addition, the second position adjuster (150B) operates to narrow the gap between the third vent (133B) and the fourth vent (134B) upon the gas removal process after the piercing process.

In the venting step, the gap of the pair of vents in the first gas remover (130A) and the second gas remover (130B) is adjusted to the second gap (Dv). The second gap (Dv) may be narrower than the first gap (Dp).

For example, when the first gap (Dp) is 5.5 mm, the second gap (Dv) may be 2.5 mm. The second gap (Dv) considers the state where the gas pocket (5) of the battery cell (1A) is expanded by gas.

After the piercing step and before the venting step, the first position adjuster (150A) adjusts the gap between the pair of vents (133A, 134A) in the first gas remover (130A) to the second gap (Dv), and the second position adjuster (150B) adjusts the gap between the pair of vents (133B, 134B) in the second gas remover (130B) to the second gap (Dv).

In this instance, the vacuum (136) of the second vent (134A) and the vacuum (136) of the third vent (133B) contact both sides of the gas pocket (5) of the first battery cell (1A). The vacuums (136) of the second vent (134A) and the third vent (133B) are positioned to cover the degas hole (7) of the first battery cell (1A). The vacuums (136) suck the gas in the gas pocket (5).

Upon operation of the vacuums (136) of the second vent (134A) and the third vent (133B), the gas generated in the first battery cell (1A) during the activation process may be removed.

Referring to FIG. 14, in the sealing step, the gap between the pair of vents in the first gas remover (130A) and the second gas remover (130B) is adjusted to the third gap (Ds).

After the venting step and before the sealing step, the first position adjuster (150A) adjusts the gap between the first vent (133A) and the second vent (134A) in the first gas remover (130A) to the third gap (Ds). For example, when the first gap (Dp) is 5.5 mm, the third gap (Ds) may be 6.0 mm. In addition, the second position adjuster (150B) adjusts the gap between the third vent (133B) and the fourth vent (134B) to the third gap (Ds).

When the pair of vents is adjusted to the third gap (Ds), the sealer (137) of the second vent (134A) and the sealer (137) of the third vent (133B) contact both sides of the gas pocket (5) of the first battery cell (1A). Each sealer (137) provides heat to the region containing the degas hole of the gas pocket (5), thereby sealing the degas hole region of the first battery cell (1A).

When the sealing step of the first battery cell (1A) is completed, the first position adjuster (150A) adjusts the positions of the first vent (133A) and the second vent (134A) so that the first vent (133A) and the second vent (134A) become closer to each other. In addition, the second position adjuster (150B) operates in the same manner as the first position adjuster (150A), and the first gas remover (130A) and the second gas remover (130B) are separated from the first battery cell (1A).

The preferred examples of the present disclosure as described above have been disclosed for illustrative purposes, and those skilled in the art having ordinary knowledge of the present disclosure will be able to make various modifications, changes, and additions within the spirit and scope of the present disclosure, and such modifications, changes, and additions should be regarded as falling within the scope of the following claims.

### INDUSTRIAL APPLICABILITY

According to the battery cell formation device related to at least one example of the present disclosure, the gas remover may be integrated into the pressure plate for pressurizing the battery cells, whereby it may be possible to promote miniaturization of the device, and by performing the gas removal process for each battery cell during the activation process on the plurality of battery cells, it may be possible to improve the activation efficiency of the battery cells.

1. A battery cell formation device comprising:
a jig including a plurality of pressure plates movable to pressurize a plurality of battery cells;
a gas remover movable with a pressure plate of the plurality of pressure plates, and coupled to the pressure plate to face a gas pocket of the battery cell in contact with the pressure plate; and
a position adjuster to adjust a position of the gas remover at the one pressure plate.

2. The battery cell formation device according to claim 1, wherein
the position adjuster is movable together with the pressure plate.

3. The battery cell formation device according to claim 2, further comprising:
a first rail extending along a moving direction of the pressure plate and provided at the pressure plate to guide movement of the gas remover; and
a frame disposed apart from the pressure plate and provided with a guide rail to guide a movement of the position adjuster in the moving direction of the pressure plate.

4. The battery cell formation device according to claim 3, wherein
the gas remover comprises first and second vents, each vent to perform a gas removal process in a gas pocket of the battery cell disposed toward a first surface of the pressure plate and the gas pocket of the battery cell disposed toward a second surface of the pressure plate in an opposite direction to the first surface, respectively.

5. The battery cell formation device according to claim 4, wherein
the first and second vents are each provided to be movable at the pressure plate, and
the position adjuster is provided to adjust a gap between the first and second vents.

6. The battery cell formation device according to claim 4, wherein the first and second vents each comprise
a piercer to form a degas hole at the gas pocket of the battery cell;
a vacuum to apply vacuum pressure to the degas hole and to suck gas out of the gas pocket; and
a sealer to seal the degas hole.

7. The battery cell formation device according to claim 6, wherein
the vacuum is provided to surround the piercer, and
the sealer is provided to surround the vacuum.

8. The battery cell formation device according to claim 7, wherein
the sealer is provided to seal a region with a diameter larger than that of the degas hole.

9. The battery cell formation device according to claim 7, wherein
the vacuum is provided to protrude toward the gas pocket of the battery cell rather than the sealer.

10. The battery cell formation device according to claim 6, wherein
the first and second vents are provided so that centers of the respective piercers are not located on same side.

11. The battery cell formation device according to claim 6, wherein
the position adjuster adjusts a gap between the first and second vents to a first gap upon operation of the piercer, and
the position adjuster adjusts the gap between the first and second vents to a second gap, which is narrower than the first gap, upon operation of the vacuum.

12. The battery cell formation device according to claim 11, wherein
the position adjuster adjusts the gap between the first and second vents to a third gap, which is larger than the first gap, upon operation of the sealer.

13. The battery cell formation device according to claim 4, wherein the position adjuster comprises:
a vent driver movably coupled to the guide rail;
a first connector connecting the first event provided at the pressure plate and the vent driver; and
a second connector connecting the second vent provided at the pressure plate and the vent driver, and
the vent driver is provided to adjust a gap between the first and second connectors.

14. The battery cell formation device according to claim 13, wherein
the vent driver comprises a motor or a cylinder.

15. The battery cell formation device according to claim 13, wherein
the position adjuster further comprises one or more joints connecting the first connector and the second connector, and
the joint comprises a first link hinge-connected to each of the first connector and the second connector, a second link disposed to intersect the first link and hinge-connected to each of the first connector and the second connector, and a hinge axis connecting the first link and the second link in an intersection region of the first link and the second link.
